(19) United States
(12) Patent Application Publication
(10) Pub. No.: US 2013/0109015 A1
(43) Pub. Date: May 2, 2013

(54) Single Nucleotide Polymorphisms Associated with Left Ventricular Hypertrophy and Use Thereof

(71) Applicants: Yang-Soo Jang, Seoul (KR); Dong-Jik Shin, Seoul (KR); Sang-Hak Lee, Seoul (KR); Berm-Seok Oh, Seoul (KR); Kyung-Won Hong, Seoul (KR)

(72) Inventors: Yang-Soo Jang, Seoul (KR); Dong-Jik Shin, Seoul (KR); Sang-Hak Lee, Seoul (KR); Berm-Seok Oh, Seoul (KR); Kyung-Won Hong, Seoul (KR)

(73) Assignees: Industry-Academic Cooperation Foundation, Kyunghee University, Yongin-si (KR); Industry-Academic Cooperation Foundatin, Yonsei University, Seoul (KR)

(21) Appl. No.: 13/569,480

(22) Filed: Aug. 8, 2012

(30) Foreign Application Priority Data
Nov. 2, 2011 (KR) 10-2011-0113099

(51) Int. Cl. G01N 21/64

(52) U.S. Cl. 435/6.11

(57) ABSTRACT

The present invention relates to single nucleotide polymorphisms associated with left ventricular hypertrophy and use thereof. The present invention provides a convenient and high reliable in vitro diagnosis system for left ventricular hypertrophy and cardiovascular diseases.

### CROSS-REFERENCE TO RELATED APPLICATIONS

This application claims priority under 35 U.S.C. §119 to Korean Patent Application No. 10-2011-0113099, filed on Nov. 2, 2011, in the Korean Intellectual Property Office, the disclosure of which is incorporated herein by reference in its entirety.

### BACKGROUND OF THE INVENTION

1. Field of the Invention

The present invention relates to single nucleotide polymorphisms (SNPs) associated with left ventricular hypertrophy and use thereof.

2. Description of the Related Art

Left ventricular hypertrophy (LVH) is a major risk factor for cardiovascular (CV) morbidity and mortality. Left ventricular hypertrophy is diagnosed by electrocardiography (ECG) and echocardiography (ECHO) (Kannel W B et al., Am J Cardiol 60(17):851-931 (1987), Levy D et al., N Engl J Med 322(22):1561-1566 (1990), Prineas R J et al., J Electrocardiol 34(2):91-101 (2001), Schillaci G et al., Hypertension 35(2): 580-586 (2000).

ECHO is a more sensitive and specific method of detecting LVH than ECG, but its use in large-scale population studies and clinical trials is limited by its prohibitive cost and operational considerations (Reichek N et al., Circulation 63(6):1391-1398 (1981).

In contrast, ECG is widely available, inexpensive, and less operator-dependent (Rautaharju P M et al., J Electrocardiol 31(1):17-29 (1998)). Thus, ECG data are obtainable in nearly all patients and participants in epidemiological studies (Mayosi B M et al., Eur Heart 23(24): 1963-1971 (2002)).

Left ventricular hypertrophy is a multifactorial trait. Its major determinants include blood pressure, age, gender, and obesity (Post WS et al., Curr Opin Cardiol 9(5):534-541 (1994)). In addition, certain genetic factors, such as angiotensin-converting enzyme (Doolan G et al., Int J Cardiol 96(2):157-163 (2004)), guanine nucleotide-binding protein (GNB3) (Semplicini A et al., Am J Hypertens 14(12):1191-1195 (2001)), insulin-like growth factor (IGF-1) (Nagy Z et al., J Am Soc. Nephrol 10(8):1709-1716 (1999)) and neuropeptide Y (NPY) (Kuch-Wocial A et al., Clin Chim Acta 345(1-2):43-47 (2004)) regulate the development of LVH.

Several studies have reported a relationship between LVH and variations in genes that are associated with the renin-angiotensin-aldosterone system (RAAS) (Frey U H et al., Eur Heart J 29(7):888-897 (2008), Smilde T D et al., Am J Hypertens 20(10):1097-1103 (2007)) and nitric oxide synthase (Xin Y et al., Clin Sci (Lond) 117(2):67-73 (2009)).

Recently, the EchoGen consortium (n=16,706 subjects of European ancestry, based on five community cohorts) performed a seminal genomewide association study (GWAS) on cardiac structure, based on ECHO measurements (Vasan R S et al., JAMA 302(2):168-178 (2009)). The GWAS identified one locus (6q22) that correlated with LV diastolic dimensions and four loci (5q23, 12p12, 12q14 and 17p13) that were linked to the aortic root size. Its results, however, explained merely 1-3% of the trait variance that was observed (Vasan R S et al., JAMA 302(2):168-178 (2009)). Considering that the heritability estimate of LV mass ranges between 0.17 and 0.59, many genetic factors remain to be identified (Arnett D K et al., Am J Hypertens 14(12):1226-1230 (2001), Bella J N et al., J Hypertens 22(2):281-286 (2004), Post W S et al., Hypertension 30(5):1025-1028 (1997), Sharma P et al., J Hypertens 24(2):321-324 (2006)).

Most studies that have sought to determine the genetic influence on LVH have used ECHO to measure LV mass. A family study by Mayosi group estimated higher heritability rates for LVH detected by ECG (ECG-LVH) (39-41%) compared with LVH determined by ECHO (ECHO-LVH) (21-29%), suggesting that there may be greater genetic susceptibility for ECG-LVH (Mayosi B M et al., Eur Heart J 23(24):1963-1971 (2002), Mayosi B M et al., Eur Heart J 29(4):525-530 (2008)).

The present invention is the first GWAS on ECG-LVH using population-based community cohorts and validates the results in hospital based samples to identify genetic risk factors that influence the development of ECG-LVH.

Throughout this application, various patents and publications are referenced and citations are provided in parentheses. The disclosure of these patents and publications in their entities are hereby incorporated by references into this application in order to more fully describe this invention and the state of the art to which this invention pertains.

### SUMMARY OF THE INVENTION

The present inventors have made intensive researches to develop a convenient and high reliable in vitro diagnosis system for LVH which is a major cause of cardiovascular diseases. As a result, the present inventors have discovered a number of SNPs associated with LVH in loci, most preferably, the RYR1 gene.

Therefore, it is an object of this invention to provide a method for identifying left ventricular hypertrophy (LVH) or an increased risk of developing LVH in a human subject.

Other objects and advantages of the present invention will become apparent from the detailed description to follow taken in conjugation with the appended claims and drawings.

### BRIEF DESCRIPTION OF THE DRAWINGS

FIG. 1 shows a quantile-quantile plot of the GWAS (333,651 SNPs) performed using community based LVH group (n=398) and control (n=8,432).

FIGS. 2A and 2B shows manhattan plot for the GWAS result.

FIGS. 3A-3H shows signal plots for eight loci of ECG-LVH GWAS, (3A) 5q35.1 (rs265992), (3B) 6p22.3-22.1 (rs9295629), (3C) 8q24.2 (rs4909705), (3D) 11p15 (rs17446021), (3E) 11q21-q22.1 (rs11225822), (3F) 14q12 (rs1956217), (3G) 17q11.2 (rs4239268), and (3H) 19q13.1 (rs10500279).

FIG. 4 shows signal plot for RYR1 locus in the GWAS (•), replication study signal (★) and combined study (⋆). Open circle indicates SNPs showing high pair-wise linkage disequilibrium (r²>0.8) and closed triangle indicates nonsynonymous SNPs. The three SNPs genotyped in the replication study are circled.

### DETAILED DESCRIPTION OF THIS INVENTION

In one aspect of this invention, there is provided a method for identifying left ventricular hypertrophy (LVH) or an increased risk of developing LVH in a human subject, comprising:

(a) obtaining a biological sample from the human subject; and

(b) identifying at least one single nucleotide polymorphism (SNP) in the biological sample, wherein the SNP is selected from the group consisting of: position 301 in SEQ ID NO:1, position 201 in SEQ ID NO:2, and position 201 in SEQ ID NO:3 as SNPs of RYR1 (ryanodine receptor 1) gene; position 201 in SEQ ID NO:4 as a SNP of DRD1 (dopamine receptor D1) gene; position 256 in SEQ ID NO:5 as a SNP of TTRAP (toll-interleukin 1 receptor domain containing adaptor protein) gene; position 201 in SEQ ID NO:6, position 502 in SEQ ID NO:7, position 301 in SEQ ID NO:8, and position 960 in SEQ ID NO:9 as SNPs of FAM135B (family with sequence similarity 135, member B) gene; position 301 in SEQ ID NO:10 as a SNP of GALNTL4 (UDP-N-acetyl-alpha-D-galactosamine: polypeptide N-acetylgalactosaminyltransferase-like 4) gene; position 251 in SEQ ID NO:11 as a SNP of DYNC2H1 (dynein, cytoplasmic 2, heavy chain 1) gene; and position 401 in SEQ ID NO:12 as a SNP of DNAJC7 (DnaJ (Hsp40) homolog, subfamily C, member gene, and wherein the presence of: a G allele at position 301 in SEQ ID NO:1, a G allele at position 201 in SEQ ID NO:2, an A allele at position 201 in SEQ ID NO:3, an A allele at position 201 in SEQ ID NO:4, a T allele at position 256 in SEQ ID NO:5, a C allele at position 201 in SEQ ID NO:6, a T allele at position 502 in SEQ ID NO:7, a T allele at position 301 in SEQ ID NO:8, an A allele at position 960 in SEQ ID NO:9, an A allele at position 301 in SEQ ID NO:10, a C allele at position 251 in SEQ ID NO:11, or a C allele at position 401 in SEQ ID NO:12 is indicative of the development of LVH or the increased risk of developing LVH in the human subject.

The present inventors have made intensive researches to develop a convenient and high reliable in vitro diagnosis system for LVH which is a major cause of cardiovascular diseases. As a result, the present inventors have discovered a number of SNPs associated with LVH in loci, most preferably, the RYR1 gene.

LVH is a major complication of hypertension and a major cause of cardiovascular diseases. Especially, cardiovascular changes by hypertension during childhood and adolescence are very likely to be LVH.

In the preset invention, LVH has been diagnosed by ECG based on the Minnesota Code Classification System (Tuinstra C L et al., J Electrocardiol 15(4):345-350 (1982)), and if R amplitude is >26 mm in V5 or V6; R amplitude >20 mm in leads I, II or III; or aVF or R amplitude >12 mm in the lead aVL, it is determined as LVH. In order to increase reliability for statistic results of LVH-diagnosed case and control, the present inventors have adjusted the results by including antihypertensive treatment status, group, age, sex, BMI, SBP, DBP, HDL, LDL, triglyceride levels, and fasting glucose levels as covariate.

The present inventors have analyzed genotypes of 8,830 KARE subjects and 804-replication study subjects, as a result, we have discovered strong evidences that some SNPs are associated with LVH. According to the present invention, it is discovered that three SNPs located in the RYR1(ryanodine receptor 1) gene, one SNP located in the DRD1 (dopamine receptor D1) gene, one SNP located in the TRAP (toll-interleukin 1 receptor domain containing adaptor protein) gene, four SNPs located in the FAM135B (family with sequence similarity 135, member B) gene, one SNP located in the GALNTL4 (UDP-N-acetyl-alpha-D-galactosamine:polypeptide N-acetylgalactosaminyltransferase-like 4) gene, one SNP located in the DYNC2H1 (dynein, cytoplasmic 2, heavy chain 1) gene, and one SNP located in the DNAJC7 (DnaJ (Hsp40) homolog, subfamily C, member 7) gene are strongly associated with LVH.

According to the present invention, where the presence of a G allele at position 301 in SEQ ID NO:1, of a G allele at position 201 in SEQ ID NO:2, of an A allele at position 201 in SEQ ID NO:3, of an A allele at position 201 in SEQ ID NO:4, of a T allele at position 256 in SEQ ID NO:5, of a C allele at position 201 in SEQ ID NO:6, of a T allele at position 502 in SEQ ID NO:7, of a T allele at position 301 in SEQ ID NO:8, of an A allele at position 960 in SEQ ID NO:9, of an A allele at position 301 in SEQ ID NO:10, of a C allele at position 251 in SEQ ID NO:11, or of a C allele at position 401 in SEQ ID NO:12 is detected in a human subject, it is determinative that the human subject has LVH or an increased risk of developing LVH. The alleles are minor alleles of the present SNPs (Table 2).

According to a preferred embodiment, the identification of LVH or the risk for LVH development (particularly, the risk for LVH development) by the present invention is compliable with that identified by the conventional ECG.

According to a preferred embodiment, the SNP useful in the present invention may be selected from the group consisting of position 301 in SEQ ID NO:1 (GenBank SNP database rs2071090), position 201 in SEQ ID NO:2 (GenBank SNP database rs10500279), position 201 in SEQ ID NO:3 (GenBank SNP database, rs2960321), position 201 in SEQ ID NO:4 (GenBank SNP database rs265992), position 256 in SEQ ID NO:5 (GenBank SNP database rs9295629), position 201 in SEQ ID NO:6 (GenBank SNP database rs6577840), position 502 in SEQ ID NO:7 (GenBank SNP database rs4909705), position 301 in SEQ ID NO:8 (GenBank SNP database, rs7825068), position 960 in SEQ ID NO:9 (GenBank SNP database, rs7840530), position 301 in SEQ ID NO:10 (GenBank SNP database rs17446021), position 251 in SEQ ID NO:11 (GenBank SNP database rs11225822), and position 401 in SEQ ID NO:12 (GenBank SNP database rs4239268).

According to a more preferred embodiment, the SNP useful in the present invention may be selected from the group consisting of position 301 in SEQ ID NO:1 (GenBank SNP database rs2071090), position 201 in SEQ ID NO:2 (GenBank SNP database rs10500279), and position 201 in SEQ ID NO:3 (GenBank SNP database, rs2960321).

According to a more preferred embodiment, the SNP may be at position 301 in SEQ ID NO:1 (GenBank SNP database rs2071090).

According to a preferred embodiment, the biological sample to be examined includes any type of nucleic acids such as gDNA, cDNA and mRNA.

According to a preferred embodiment, the biological sample includes tissue, cell, whole blood, serum, plasma, peripheral blood leukocyte, saliva, semen, urine, synovia and spinal fluid.

The term used herein “risk” refers to the possibility or probability of a particular event (e.g., developing LVH or CV disease) occurring either presently or at some time point in the future.

The term used herein “association” refers to statistically significant events in the relationship between polymorphisms at a gene and phenotypes of the corresponding individual. The term “association” means cases in which p-value for statistical results indicating the relationship between the presence of a SNP and the identification of LVH by ECG is less than or equal to 1×10⁻⁵.

According to the result of KARE GWAS, p-value for the twelve SNPs has been shown as low as no more than 1×10⁻⁵, addressing that the SNPs are strongly associated with LVH (Table 2). Especially p-values for three SNPs having higher association, rs2071090, rs10500279 and rs2960321, were p=2.2×10⁻⁶, p=9.5×10⁻⁷ and p=2.0×10⁻⁶, respectively.

The term used herein “nucleotide” refers to a deoxyribonucleotide or a ribonucleotide existing in the forms of single strand or double strands, which may also include analogs of natural nucleotides (Scheit, Nucleotide Analogs, John Wiley, New York (1980); Uhlman and Peyman, Chemical Reviews, 90:543-584 (1990)).

The term used herein “single nucleotide polymorphism” or “SNP” refers to a DNA sequence variation occurring when a single nucleotide—A, T, C or G—in the genome (or other shared sequence) differs between members of species (or between paired chromosomes in an individual). For example, when there is a single nucleotide difference in three DNA fragments from different individuals—AAGT[A/A]AG, AAGT[A/G]AG and AAGT[G/G]AG—it is called two alleles (C or T), and almost SNPs may have two alleles generally. In a population, SNP may be assigned to Minor allele frequency (MAF: the lowest allele frequency on locus discovered in particular population). The single nucleotide may be altered (substituted), removed (deleted) or added (inserted) on a polynucleotide sequence. The SNP may lead to alterations of translation flame.

Single nucleotide polymorphisms may be located in the coding sequence of genes, the non-coding region of genes or the intergenic regions between genes. The SNP in the coding sequence may do not lead to alterations of an amino acid sequence of target protein due to the degeneracy of the genetic code. A SNP forming identical polypeptide sequence is referred to synonymous (it is referred to a silent mutation), and a SNP forming different polypeptide sequence is referred to non-synonymous. The non-synonymous SNP may be missense or nonsense, while the missense alteration generates different amino acid, the nonsense alteration forms non-mature stop codon. The SNP located in a non-coding region may cause gene silencing, transcription factor binding or non-coding RNA sequence.

The variation of a human DNA sequence may influence on an outbreak of diseases and human response to pathogens, chemicals, drugs, vaccines and other agents. In addition, SNP is considered as a key enabler to realize a concept of customized drugs. Above all things, SNP, which is developed as a marker recently, is the most important for biomedical study to diagnose diseases by comparing one group having a disease with another group having no disease. SNP is the major variation of human genome, and it is speculated that one SNP exists in genome per 1.9 kb (Sachidanandam et al., 2001). SNP is a very stable genetic marker and has occasionally influence on phenotype directly, and is very suitable for automatic genotype-determining system. In addition, a SNP study is important for cereal crops and livestock cultivation system.

According to a preferred embodiment, the method of this invention may be carried out using the present kit which comprises a primer or a probe specific to a continuous adjacent nucleotide sequence in length of 10-100 bps including the SNP region of the present invention.

The term used herein “primer” refers to an oligonucleotide, whether occurring naturally as in a purified restriction digest or produced synthetically, which is capable of acting as a point of initiation of synthesis when placed under conditions in which synthesis of a primer extension product which is complementary to a nucleic acid strand is induced, i.e., in the presence of four different nucleoside triphosphates and a thermo stable enzyme in an appropriate buffer and at a suitable temperature. Preferably, the primer is a deoxynucleotide and single strand. The primer used in the present invention can be comprised of naturally occurring dNMP (i.e., dAMP, dGMP, dCMP and dTMP), modified nucleotide or non-natural nucleotide. The primer may also include ribonucleotide.

The primer used in the present invention may be an extension primer which is annealed to a target nucleic acid, thereby forming a complementary sequence to the target nucleic acid by a template-dependent ploymerase, which is extended up to the position at which an immobilized probe is annealed, whereby occupying the position.

The extension primer used in the present invention includes a hybridizing nucleotide sequence complementary to a first region of a target nucleic acid. The term “complementary” is used herein to mean that primers or probes are sufficiently complementary to hybridize to a target nucleic acid sequence selectively under the designated annealing conditions or stringent conditions, encompassing the terms “substantially complementary” and “perfectly complementary”, preferably perfectly complementary. The term used herein “a sequence substantially complementary” refers to not only a fully consensus sequence with a target sequence but also a partially consensus sequence with it, so long as the sequence can anneal to specific target sequence as a primer.

Primers should be sufficiently long for priming of a synthesis of primer extension product. The suitable length of the primer is dependent on many factors including temperature, application and source of primer, generally, 15-30 nucleotides in length. Shorter primers generally need lower temperature to form stable hybridization duplex to templates. The term used herein “annealing” or “priming” refers to the apposition of an oligonucleotide or nucleic acid to a template nucleic acid, whereby said apposition enables a polymerase to polymerize nucleotides into a nucleic acid which is complementary to the template nucleic acid or a portion thereof.

The sequence of the primer is not required to have perfectly complementary sequence to templates. The primer sequence may comprise some mismatched, so long as they can be hybridized with templates and serve as primers. Therefore, the primer of this invention is not required to have perfectly complementary sequence to above-mentioned nucleotide sequence; it is sufficient that they have complementarity to the extent that they anneals specifically to the nucleotide sequence of the gene for acting as a primer. Design of these primers may be performed by a person skilled in the art referring to the nucleotide sequence, for example, the primer design may be carried out using computer programs for primer design (e.g., PRIMER3 program).

The term used herein “nucleic acid molecule” refers to a comprehensive DNA (gDNA and cDNA) and RNA molecule, and a nucleotide as a basic unit in the nucleic acid includes not only natural nucleotides but also analogues which a sugar or base are modified (Scheit, Nucleotide Analogs, John Wiley, New York (1980); Uhlman and Peyman, Chemical Reviews, 90:543-584 (1990)).

When a start material of the present kit is gDNA, its isolation may be performed by general methods as known in the art (Rogers & Bendich (1994)).

When the start material is mRNA, total RNA may be isolated by general methods as known in the art (Sambrook, J. et al., Molecular Cloning. A Laboratory Manual, 3rd ed. Cold Spring Harbor Press (2001); Tesniere, C. et al., Plant Mol. Biol. Rep., 9:242 (1991); Ausubel, F. M. et al., Current Protocols in Molecular Biology, John Willey & Sons (1987); and Chomczynski, P. et al., Anal. Biochem, 162:156 (1987)). Isolated total RNA is synthesized to cDNA using reverse transcriptase. Because the total RNA is isolated from human (e.g., LVH or cardiovascular disease patients), end of mRNA has poly-A tail. The cDNA is easily synthesized using oligo dT primers and reverse transcriptase (PNAS USA, 85:8998 (1988); Libert F, et al., Science, 244:569 (1989); and Sambrook, J. et al., Molecular Cloning. A Laboratory Manual, 3rd ed. Cold Spring Harbor Press (2001)).

In the present kit, analysis of the specific sequence is performed by applying a variety of methods as known in the art. For example, the method which are applied to the present invention includes, but is not limited to, fluorescent in situ hybridization (FISH), direct DNA sequencing, PFGE analysis, single stranded conformation analysis (SSCA; Orita et al., PNAS, USA 86:2776 (1989)), RNase protection assay (Finkelstein et al., Genomics, 7:167 (1990)), dot blot analysis, denaturing gradient gel electrophoresis (DGGE, Wartell et al., Nucl. Acids Res., 18:2699 (1990)) and allele-specific PCR.

Sequence changes lead to difference in base combination in single-strand molecules, whereby appearing bands which are different from each other in mobility, SSCA is capable of detecting these bands. The DGGE analysis detects a sequence which is different from wild type sequence in mobility using denaturing gradient gel.

Generally, other methods employ a probe or a primer complementary to a sequence including SNP. For example, riboprobes are used in RNase protection assay. The riboprobes are hybridized with DNA or mRNA from human, and resultants are cut with RNase A enzyme capable of detecting a mismatch. If the RNase A is recognized to the mismatch, smaller bands are observed.

Probes complementary to a sequence including SNP of this invention are used in analysis using hybridization signals. In this method, DM or MS is directly determined by detecting hybridization signals between the probe and a target sequence.

The term “probe” used herein refers to a linear oligomer of natural or modified monomers or linkages, including deoxyribonucleotides, ribonucleotides and the like, which is capable of specifically hybridizing with a target nucleotide sequence, whether occurring naturally or produced synthetically. Preferably, the probe is single strand for maximum efficiency of hybridization. Preferably, the probe is deoxyribonucleotide.

In the present invention, a sequence perfectly complementary to a sequence including the SNP may be used as a probe, and a sequence substantially complementary to a sequence including the SNP may be also used, so long as it does not interrupt specific hybridizations. Preferably, the probe used in this invention includes a sequence hybridized with 10-30 continuous nucleotide sequences including the SNP of this invention. More preferably, 3′-end or 5′-end of the probe has a base sequence complementary to a base sequence for SNP. Generally, because stability of a duplex formed by hybridization is dependent on consensus of a terminal sequence, unless 3′-end or 5′-end of the probe having a base sequence complementary to a base sequence for SNP is hybridized, such duplex may be taken away under stringent conditions.

Conditions for suitable hybridization may be determined referring to disclosures in Joseph Sambrook, et al., Molecular Cloning, A Laboratory Manual, Cold Spring Harbor Laboratory Press, Cold Spring Harbor, N.Y. (2001) and Haymes, B. D., et al., Nucleic Acid Hybridization, A Practical Approach, IRL Press, Washington, D.C. (1985). Stringent conditions used for hybridization may be determined by adjusting temperature, ionic strength (buffer concentrations) and the presence of compounds such as organic solvent. Such Stringent condition may be determined depending on hybridized sequences.

According to a preferred embodiment, a human subject having the minor allele is of the present SNPs has an increased risk of developing LVH.

According to another preferred embodiment, a human having the minor allele has an increased risk of developing a cardiovascular disease. More preferably, the cardiovascular disease is arrhythmia, hypertension, stroke, arteriosclerosis, atherosclerosis, angina, myocardial infarction or heart failure.

Arrhythmia indicates abnormal cardiac rhythm and too fast or too slow heart rate. Arrhythmia is condition that heart beat is irregular due to being abnormalities in the cardiac conduction system, or a chest stays motionless but heart is too fast beating or too slow beating, and causes of arrhythmia are arteriosclerosis, virus, drug, electrolyte abnormality, alcohol, apriority or various heart diseases.

Hypertension maintains a state of high blood pressure, which can be considerably changed according to various factors including position for measuring blood pressure, measure time and weather, exercise, emotion and the like, but hypertension refers to condition that blood pressure is always high. Specifically, Hypertension is divided into pre-hypertension (systolic blood pressure: 120-139 mmHg, diastolic blood pressure: 80-89 mmHg), mild hypertension (systolic blood pressure: 140-159 mmHg, diastolic blood pressure: 90-99 mmHg), moderate hypertension (systolic blood pressure: 160-179 mmHg, diastolic blood pressure: 100-109 mmHg), and severe hypertension (systolic blood pressure: more than 180 mmHg, diastolic blood pressure: 110 mmHg).

Stroke refers to brain damage caused by blood flow disorder of brain, which is divided into hemorrhagic stroke, thrombotic stroke, and embolic Stroke. Hemorrhagic stroke refers to brain damage caused by shortage of blood flow which is occurred by contraction of blood vessel around blooding occurred in cerebral ventricle or between brain and cranium. Thrombotic stroke is occurred when blood clots formed in brain blood vessels block blood flow, which is generally occurred in narrow artery by arteriosclerosis. Embolic Stroke is occurred when blood clots or tiny masses move to brain along blood vessel and then block blood vessel of brain, which is generally occurred by blood clots formed by slowed blood flow in heart. It can be occurred from atrial fibrillation or severe heart failure.

Arteriosclerosis refers to symptoms that arteries loss elasticity and its diameter narrows because of abnormal thickness of artery inner walls caused by sticking of fatty substances on the arteries inner walls. Arteriosclerosis is caused by many factors including normal aging process, disorders of lipid metabolism or metabolic disorder of hormones, genetic factors, dietary life, lack of exercise and the like, which is generally occurred not one factor but a number of factors which are hypertension, hyperlipemia, diabetes, smoking, obesity, stress and the like.

Angina refers to a feeling of chest pressure or pain due to lack of blood supply, and one of the coronary heart diseases. Angina is divided into stable angina, unstable angina and variant form of angina pectoris (Prinzmetal angina). Stable angina is occurred by arteriosclerosis as a major cause, and pain is emerged in the case of taking exercise or food overly, or feeling of anxiety or excitement. In unstable angina, pain is emerged during even a rest or sleep, and existed chest pain is gradually increased. Unstable angina is a risk factor for heart attack. In variant form of angina pectoris, pain is emerged by contracting the coronary artery during but sleeping not daytime. Variant form of angina pectoris may be a cause of myocardial infarction and sudden death, which is occurred in a male, and its risk factor is smoking.

Myocardial infarction refers to destruction of one portion of heart muscles due to blocking blood vessels by blood clots. Commonly, in the case of sudden death by heart attack, its cause is usually myocardial infarction. Causes of myocardial infarction are mostly coronary arteriosclerosis, and hypertension, smoking, diabetes, hyperlipemia, obesity and the like. When the coronary artery is blocked mare than 70% by arteriosclerosis, angina is occurred, and then if narrowed blood vessels is quite blocked, myocardial infarction is caused.

Heart failure refers to a state that blood cannot be to other organs due to declining pump function of heart, and many cardiac diseases may cause malfunction of contraction and relaxation of heart, whereby heart failure mat be occurred. The most common cause of heart failure is hypertension.

According to a preferred embodiment, the method of the present invention may be applied to Asian.

The term “Asia” used herein refers to the Far East in which Mongolians including Korean, Chinese, Japanese and the like reside. The term “Asian” used herein refers to a population whose ancestor is Asian, preferably a population whose ancestors of more than tenth generations are Asian.

According to a more preferred embodiment, the Asian may be Korean.

According to a preferred embodiment, the method of the present invention may be carried out by microarray analysis or gene amplification. More preferably, the amplification of the present invention may be conducted by PCR (polymerase chain reaction). More preferably, the primer may be used in gene amplification reactions.

When the method of this invention is applied to PCR amplification processes, the method of this invention may selectively include agents for PCR amplification, for example, buffer, DNA polymerase (e.g., heat-stable DNA polymerase obtained from Thermus aquaticus (Taq), Thermus thermophilus (Tth), Thermus filiformis, Thermis flavus, Thermococcus literalis or Pyrococcus furiosus (Pfu)), DNA polymerase cofactor and dNTPs. The kit for the present invention is prepared as a number of separated packaging or compartments including the agent components.

The term “amplification reaction” used herein refers to a reaction to amplify nucleotide molecules. Various amplification reactions are reported in the field of art, which include, but are not limited to, polymerase chain reaction (PCR) (U.S. Pat. Nos. 4,683,195, 4,683,202 and 4,800,159), reverse transcription-polymerase chain reaction (PT-PCR) (Sambrook et al., Molecular Cloning. A Laboratory Manual, 3rd ed. Cold Spring Harbor Press (2001)), the method of Miller, H. I. (WO 89/06700) and Davey, C. et al., (EP 329,822), ligase chain reaction (LCR), Gap-LCR (WO 90/01069), repair chain reaction (EP 439,182), transcription-mediated amplification (TMA) (WO 88/10315), self sustained sequence replication (WO 90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909 and 5,861,245), nucleic acid sequence based amplification (NASBA) (U.S. Pat. Nos. 5,130,238, 5,409,818, 5,554,517 and 6,063,603), strand displacement amplification and loop-mediated isothermal amplification (LAMP). Other amplification methods that may be used are described in U.S. Pat. Nos. 5,242,794, 5,494,810, 4,988,617 and U.S. application Ser. No. 09/854,317).

PCR is one of the most predominant processes for nucleic acid amplification, and a number of its variations and applications have been developed. For example, for improving PCR specifically or sensitivity, touchdown PCR, hot start PCR, nested PCR and booster PCR have been developed with modifying traditional PCR procedures. In addition, real-time PCR, differential display PCR (DD-PCR), rapid amplification of cDNA ends (RACE), multiplex PCR, inverse polymerase chain reaction (IPCR), vectorette PCR and thermal asymmetric interlaced PCR (TAIL-PCR) have been developed for certain applications. The details of PCR can be found in McPherson, M. J., and Moller, S. G. PCR. BIOS Scientific Publishers, Springer-Verlag New York Berlin Heidelberg, N.Y. (2000), the teachings of which are incorporated herein by reference in its entirety.

Where the method of the present invention is carried out using the primer, LVH is diagnosed by analyzing nucleotide sequences of markers of this invention with conducting the gene amplification reaction. The term “diagnosis” used herein includes determination of a subject's susceptibility to a disease or a disorder, determination of whether a subject has currently a disease or a disorder (e.g., identification of LVH or hypertension), determination of the prognosis of a subject who suffers from a certain disease or disorder, or therametrics (e.g., monitoring states of a subject to provide information about therapeutic effects). According to the present invention, using SNPs of this invention as multiple markers, when the presence of the allele is identified by the above-mentioned methods, it is determined as an increased risk of developing LVH and/or high risk for cardiovascular disease complications.

According to the most preferred embodiment, amplification processes is carried out by PCR described in U.S. Pat. Nos. 4,683,195, 4,683,202 and 4,800,159.

The method of the present invention can be carried out with microarray. When the method of this invention is conducted with microarray, probes are immobilized on surfaces thereof.

The probe used in the present methods has sequences complementary to 10-100 continuous nucleotide sequences, which include above-mentioned SNPs of the present invention, on each genetic locus.

Nucleotide sequences of the present markers to be referred for preparation of probes are identified from GenBank. For example, a nucleotide as set forth in SEQ ID NO:1, which is one marker among the present markers, is disclosed in GenBank SNP database rs2071090, a nucleotide as set forth in SEQ ID NO:2 is disclosed in GenBank SNP database rs10500279, and the probes are designed referring to these sequences.

In microarray, the probes serve as hybridizable array elements and are immobilized on substrates. A preferably substrate includes suitable solid or semi-solid supporters, such as membrane, filter, chip, slide, wafer, fiber, magnetic or nonmagnetic bead, gel, tubing, plate, macromolecule, microparticle and capillary tube. The hybridizable array elements are arranged and immobilized on the substrate. Such immobilization occurs through chemical binding or covalent binding such as UV. For example, the hybridizable array elements are bound to a grass surface modified to contain epoxy compound or aldehyde group, or to a polylysin-coated surface by UV. Further, the hybridizable array elements are bound to a substrate through linkers (e.g., ethylene glycol oligomer and diamine)

Sample DNAs to be examined with the microarray may be labeled, and hybridized with array elements on microarray. Various hybridization conditions are applicable. The detection and analysis of the extent of hybridization are conducted with various methods depending on labels used.

Label of the probes generate a signal to detect hybridization, and is linked to oligonucleotide. Suitable labels include, but are not limited to, fluorophores (e.g., fluorescein, phycoerythrin, rhodamine, lissamine, Cy3 and Cy5 (Pharmacia)), chromophores, chemiluminescers, magnetic particles, radioisotopes (e.g., P³² and S³⁵), mass labels, electron dense particles, enzymes (e.g., alkaline phosphatase and horseradish peroxidase), cofactors, substrates for enzymes, heavy metals (e.g., gold), and haptens having specific biding partners including an antibody, streptavidin, biotin, deoxigenin and chelating group. Labeling is performed according to various methods known in the art, such as nick translation, random priming (Multiprime DNA labeling systems booklet, “Amersham” (1989)) and kination (Maxam & Gilbert, Methods in Enzymology, 65:499 (1986)). The labels generate signals detectable by fluorescence, radioactivity, X-ray diffraction or absorption, magnetic force, enzymatic activity, mass analysus, biding affinity, high frequency hybridization or nanocrystal.

The nucleic acid sample to be analyzed may be prepared using mRNA from various biosamples. Instead of probes, cDNA may be labeled for hybridization-based analysis.

When probes are used, the probes are hybridized with cDNA molecules under stringent conditions for detecting the SNPs of this invention. In the present invention, suitable hybridization conditions may be routinely determined by optimization procedures. Such procedures are conducted by a person skilled in the art to establish protocols for laboratory use. For example, conditions such as temperature, concentration of components, hybridization and washing time, buffer components, and their pH and ionic strength may be dependent on various factors including the length and GC contents of probes, and target nucleotide sequence. The detailed conditions for hybridization can be found in Joseph Sambrook, et al., Molecular Cloning, A Laboratory Manual, Cold Spring Harbor Laboratory Press, Cold Spring Harbor, N.Y. (2001) and M. L. M. Anderson, Nucleic Acid Hybridization, Springer-Verlag New York Inc. N.Y. (1999). For example, the high stringent condition among the stringent conditions may refer to hybridization in 0.5 M NaHPO₄, 7% SDS (sodium dodecyl sulfate) and 1 mM EDTA at 65° C., and then washing in 0.1×SSC (standard saline citrate)/0.1% SDS at 68° C. Also, the high stringent condition may refer to hybridization in 6×SSC/0.05% sodium pyrophosphate at 48° C. The low stringent condition may refer to e.g., washing in 0.2×SSC/0.1% SDS at 42° C.

Following hybridization reactions, a hybridization signal indicative of the occurrence of hybridization is then measured. The hybridization signal may be analyzed with various methods depending on labels. For example, where probes are labeled with enzymes, the occurrence of hybridization may be detected by reacting substrates for enzymes with hybridization resultants. The enzyme/substrate pair useful in the present invention includes, but is not limited to, a pair of peroxidase (e.g., horseradish peroxidase) and chloronaphtol, aminoehylcabazol, diaminobenzidine, D-luciferin, lucigenin (bis-N-methylacridinium nitrate), resorufin benzyl ether, luminal, Amplex Red reagent (10-acetyl-3,7-dihydroxyphenoxazine), HYR (p-phenylenediamine-HCl and pyrocatechol), TMB (tetramethylbenzidine), ABTS (2,2′-Azine-di[3-ethylbenzthiazoline sulfonate]), o-phenylenediamine (OPD) or naphtol/pyronine; a pair of alkaline phosphatase and bromochloroindolyphophate (BCIP), nitro blue tetrazolium (NBT), naphtol-AS-B1-phosphate or ECF substrate; and a pair of glucosidase and t-NBT (nitroblue tetrazolium) or m-PMS (phenzaine methosulfate). Where probes are labeled with gold particles, the occurrence of hybridization may be detected by silver staining method using silver nitrate.

In these connections, where the method for detecting the present marker is carried out by hybridization, it comprises the steps of (i) contacting a nucleic acid sample to a probe having a nucleotide sequence complementary to the nucleotide sequence of the present marker; (ii) detecting the occurrence of hybridization. Obesity, diabetes or cardiovascular disease complications is determined by analyzing the signal intensity from hybridization results. That is, when the hybridization signal to the nucleotide sequence of the present marker from a sample is measured to be stronger than normal samples, the sample can be diagnosed as a high risk of developing LVH.

The present method is very useful in genetic in vitro diagnosis for LVH or CV diseases.

The present invention will now be described in further detail by examples. It would be obvious to those skilled in the art that these examples are intended to be more concretely illustrative and the scope of the present invention as set forth in the appended claims is not limited to or by the examples.

### EXAMPLES

### Methods and Materials

Original Study subjects

The Korea Association Resource (KARE) were started in 2007 and conducted large-scale GWA analysis using 10,038 two community-based cohorts (age 40-70 years)—the rural Ansung community (n=5,018) and the rural Ansan community (n=5,020) (Cho YS et al., Nat Genet 41(5):527-534 (2009)).

Subjects with genotype accuracies below 98% and high missing genotype call rates (≧4%), high heterozygosity (>30%) or inconsistency in sex were excluded from subsequent analyses. Individuals who had a tumor were excluded, as were related individuals whose estimated identity-by-state values were high (>0.80). After these quality control steps, 8,842 samples were selected, of whom 12 did not undergo ECG. Ultimately, 8,830 samples were used for the GWAS.

Left ventricular hypertrophy was diagnosed by ECG, based on the Minnesota Code Classification System (Tuinstra C L et al., J Electrocardiol 15(4):345-350 (1982)), if R amplitude is >26 mm in V5 or V6; R amplitude >20 mm in leads I, II or III; or aVF or R amplitude >12 mm in the lead aVL (all criteria were measured on the penultimate complete normal beat). Blood pressure was measured three times in the supine position, and the average value was used for the GWAS. Before the first measurement, participants rested for 5 min, and the three measurements were taken in one arm showing the higher Blood pressure at least 3 min apart. Other cardiovascular risk factors, such as cholesterol level and fasting glucose level, were measured from blood samples after overnight fasting.

### Original Study Genotypes

Most DNA samples were isolated from the peripheral blood of the subjects and Genotyping was conducted using the Affymetrix Genomewide Human SNP array 5.0 (Affymetrix, Inc., Santa Clara, Calif.). The quality control steps of genotypes referred to the study of Cho Y S (Cho YS et al., Nat Genet 41(5):527-534 (2009)). Briefly, the accuracy of the genotyping was determined by Bayesian Robust Linear Modeling using the Mahalanobis Distance genotyping algorithm (Rabbee N et al., Bioinformatics 22(1):7-12 (2006)). Consequently, 333,651 SNPs had a missing genotype call rate below 0.1, a minor allele frequency (MAF) >0.01 and no deviation from the Hardy-Weinberg equilibrium (HWE) (P>1×10⁻⁶).

### Replication Study Subjects

The replication study included 207 LVH patients and 597 normal controls selected from the patient database of the Cardiovascular Genome Center in Yonsei University Health System. Both case and control subjects were independent from those of the original GWAS study.

The patient database comprised individuals aged 40-70 years who entered the outpatient clinic or were hospitalized between May 2002 and November 2007 in the Cardiology Division of Severance Cardiovascular Hospital. EGC-LVH was diagnosed using the same criteria as in the original GWAS—the Minnesota Code Classification System (Tuinstra CL et al., J Electrocardiol 15(4):345-350 (1982)). This study was approved by the local Ethics Committee, and informed consent was obtained from all patients.

### Replication Study Genotypes

SNP selection for the replication study was based on the significance with P-value (<1×10⁻⁵). The SNPs genotyping were performed by TaqMan™ fluorogenic 5′ nuclease assay (Applied Biosystems, Foster City, Calif.). The PCR reagent was prepared by mixing genomic DNA, TaqMan™ Universal PCR Master Mix and 40× predesigned TaqMan probe Assay Mix. PCR was performed as follows: 2 min at 50° C. to activate uracil N-glycosylase and prevent contamination, 10 min at 95° C. to activate the DNA polymerase and 45 cycles of 15 s at 95° C. and 1 min at 60° C.

All reactions were run in 384-well plates on a Dual 384-Well GeneAmpw PCR System 9700 (Applied Biosystems, Foster City, Calif.) and were read on an ABI PRISM 7900 HT Sequence Detection System (Applied Biosystems, Foster City, Calif.). Duplicate samples and negative controls were included to ensure the accuracy of the genotyping data.

### Statistical Analysis

The ECG-LVH cases and controls were analysed by logistic regression, controlling for covariates, such as antihypertensive drug treatment state, cohort, age, sex, body mass index (BMI), systolic BP (SBP), diastolic BP (DBP), HDL, LDL, triglyceride and fasting glucose levels. Statistical analysis were performed using PLINK (Purcell Set al., Am J Hum Genet 81(3):559-575 (2007)) (version 1.07) and SPSS (v15.0). For the multicollinearity of covariates, the tolerance and variance inflation factor were estimated (Table 1). The asymptotic HWE tests were conducted using PLINK.

TABLE 1
Clinical characteristics of the KARE and replication study subjects

| | | | Case vs. | Collinearity | | Replication study | | Case vs. | Collinearity | |
|---|---|---|---|---|---|---|---|---|---|---|
| | KARE GWAS | | control, | statistics | | subjects | | control, | statistics | |
| — | Control | Case | P-value^{a} | Tolerance | VIF | Control | Case | P-value^{a} | Tolerance | VIF |
| n | 8432 | 398 | — | — | — | 597 | 207 | — | — | — |
| Treated^{b} (%) | 1217 | 72 | 4.3 × 10⁻² | 0.90 | 1.11 | 99 | 194 | 4.8 × 10⁻⁴³ | 0.77 | 1.30 |
| | (14) | (18) | | | | (17) | (95) | | | |
| Men (%) | 3916 | 261 | 3.0 × 10⁻⁸ | 0.90 | 1.11 | 430 | 161 | 2.5 × 10⁻¹ | 0.89 | 1.12 |
| | (46) | (66) | | | | (72) | (78) | | | |
| — | Mean | — | — | — | — | Mean | — | — | — | — |
| | (SD) | | | | | (SD) | | | | |
| Age | 52.1 | 55.1 | 2.2 × 10⁻¹¹ | 0.81 | 1.24 | 57.4 | 58.3 | 1.2 × 10⁻² | 0.88 | 1.14 |
| | (8.9) | (9.2) | | | | (7.5) | (8.0) | | | |
| Body mass | 24.6 | 23.6 | 1.1 × 10⁻¹¹ | 0.80 | 1.24 | 24.2 | 24.5 | 3.0 × 10⁻¹ | 0.92 | 1.09 |
| index | (3.1) | (2.9) | | | | (2.6) | (3.4) | | | |
| Systolic blood | 117.1 | 128.0 | 1.7 × 10⁻³¹ | 0.29 | 3.41 | 124.3 | 126.9 | 2.7 × 10⁻¹ | 0.42 | 2.35 |
| pressure | (18.0) | (20.8) | | | | (17.9) | (21.0) | | | |
| (mmHg) | | | | | | | | | | |
| Diastolic blood | 74.9 | 79.4 | 1.6 × 10⁻¹⁴ | 0.32 | 3.08 | 78.4 | 77.6 | 2.6 × 10⁻¹ | 0.43 | 2.34 |
| pressure | (11.5) | (11.7) | | | | (10.9) | (11.2) | | | |
| (mmHg) | | | | | | | | | | |
| HDL | 44.6 | 45.3 | 1.7 × 10⁻¹ | 0.80 | 1.25 | 48.9 | 44.0 | 9.7 × 10⁻⁹ | 0.90 | 1.11 |
| cholesterol | (10.1) | (10.6) | | | | (15.2) | (12.9) | | | |
| (mg/dL) | | | | | | | | | | |
| LDL | 116.0 | 110.3 | 6.8 × 10⁻⁴ | 0.93 | 1.07 | 120.1 | 97.0 | 1.2 × 10⁻² | 0.87 | 1.15 |
| cholesterol | (32.2) | (32.7) | | | | (35.3) | (33.7) | | | |
| (mg/dL) | | | | | | | | | | |
| Triglyceride | 163.0 | 162.6 | 9.4 × 10⁻¹ | 0.77 | 1.30 | 140.8 | 135.1 | 5.6 × 10⁻¹ | 0.91 | 1.10 |
| (mg/dL) | (106.1) | (98.6) | | | | (95.0) | (103.0) | | | |
| Fasting | 87.7 | 86.9 | 4.8 × 10⁻¹ | 0.94 | 1.06 | 96.1 | 114.1 | 1.6 × 10⁻⁶ | 0.84 | 1.20 |
| glucose level | (22.0) | (19.4) | | | | (27.4) | (52.1) | | | |
| (mg/dL) | | | | | | | | | | |

SD: standard deviation,
VIF: variance inflation factor
^{a}P-values between control and case were calculated using x² for treated and sex ratio and Student's t-test for quantitative traits.
^{b}Anti-hypertensive drug-treated subjects.

### Experimental Results

### Baseline Characteristics of Subjects

398 individuals out of the 8,830 community-based KARE subjects were diagnosed as ECG-LVH by the Minnesota Code Classification System. The demographics and clinical characteristics of the subjects are shown in Table 1. Antihypertensive treatment status, sex, age, BMI, SBP, DBP and LDL levels differed significantly between the ECG-LVH group (case) and control group of the KARE GWAS. Of the controls in the GWAS, 1,217 (14%) subjects had taken antihypertensive medications compared with 72 (17%) of ECG-LVH group.

In the hospital-based replication study, antihypertensive treatment status, age, HDL, LDL and fasting glucose levels differed significantly between the ECG-LVH group (case) and controls. Ninety-nine (17%) of controls and 194 (95%) ECG-LVH group have taken antihypertensive medications, respectively. To avoid the multicollinearity of covariates, the present inventors tested the tolerance and VIF of them. The test results showed all VIF values lower than 5, the suggested conservative threshold, suggesting the low multicollinearities of covariates.

### ECG-LVH GWAS

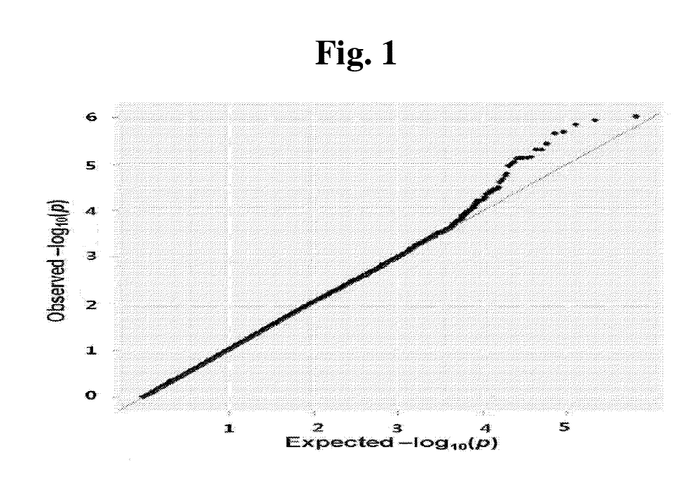

The ECG-LVH GWAS used KARE genotyped data previously reported by the study of Cho (Nat Genet 41(5):527-534 (2009)). A GWAS of 333,651 SNPs was performed using community-based LVH cases (n=398) and controls (n=8,432); a quantile-quantile (Q-Q) plot is shown in FIG. 1. The genomic inflation factor (λ) was 1.00, which was evidence against population stratification or inflated results.

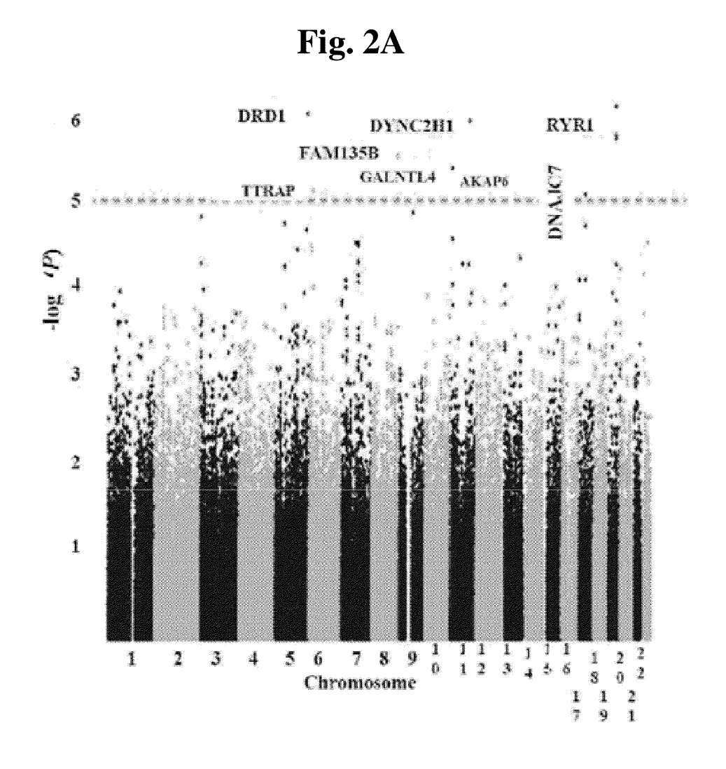

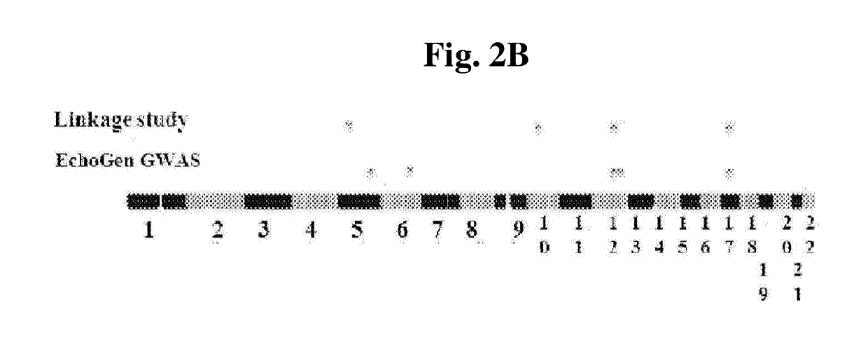

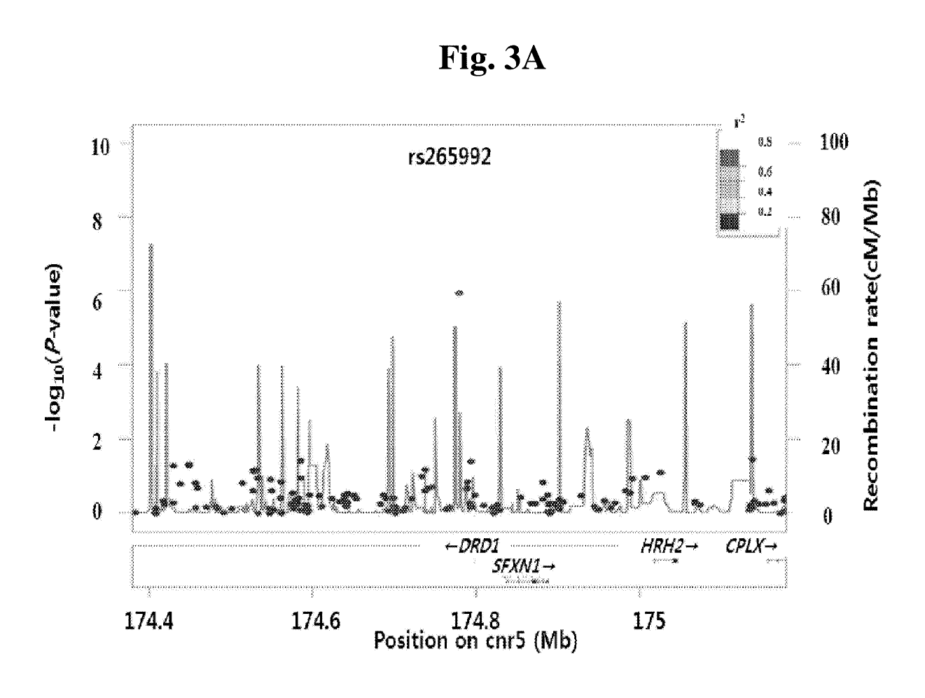

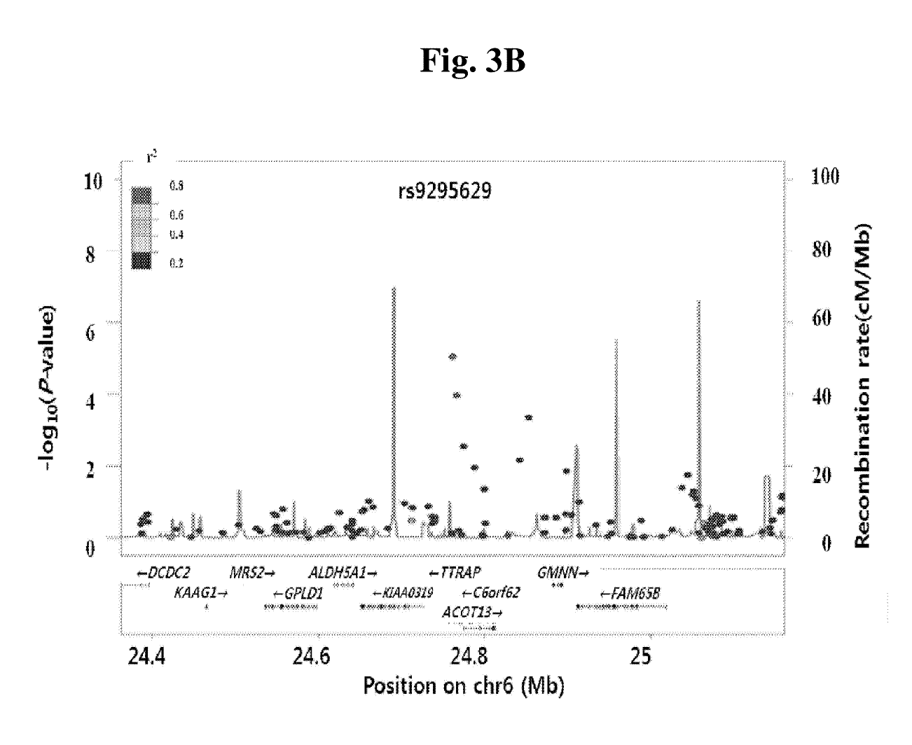

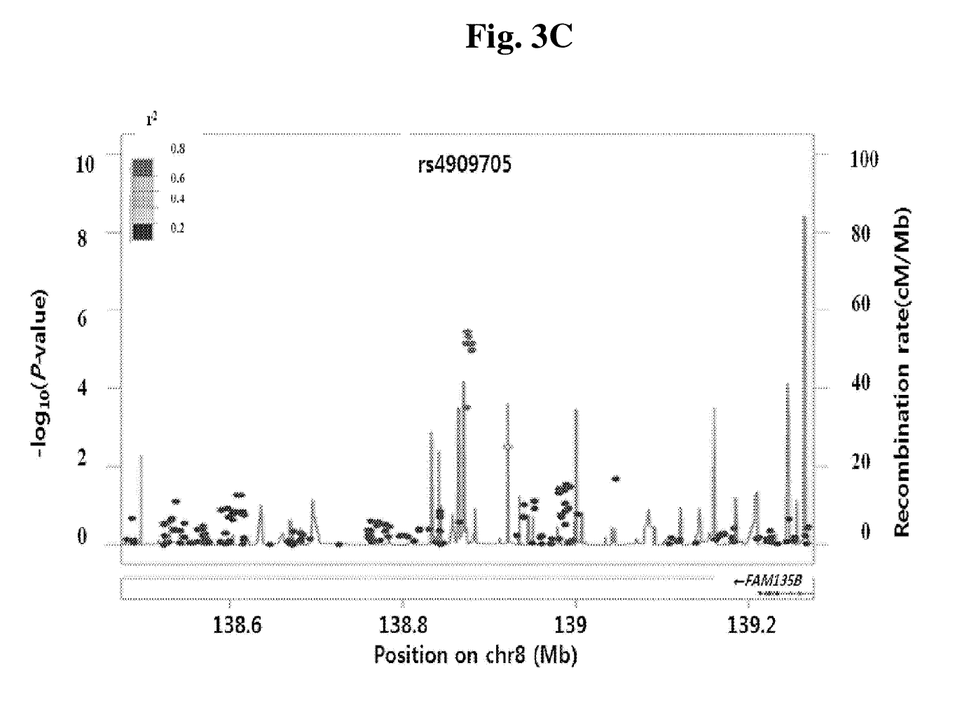

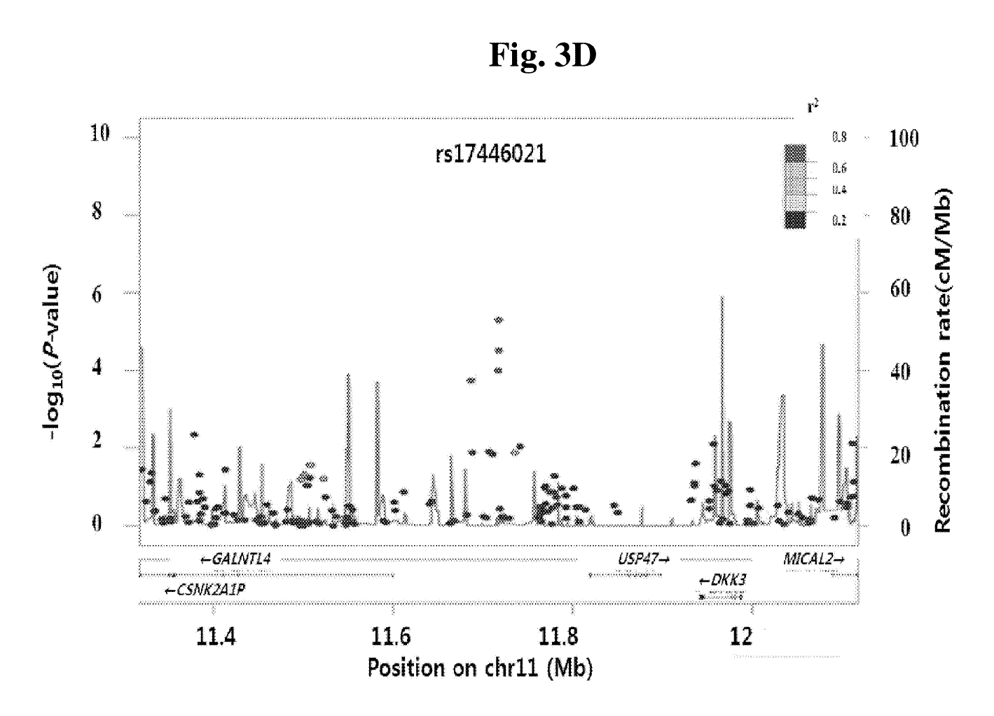

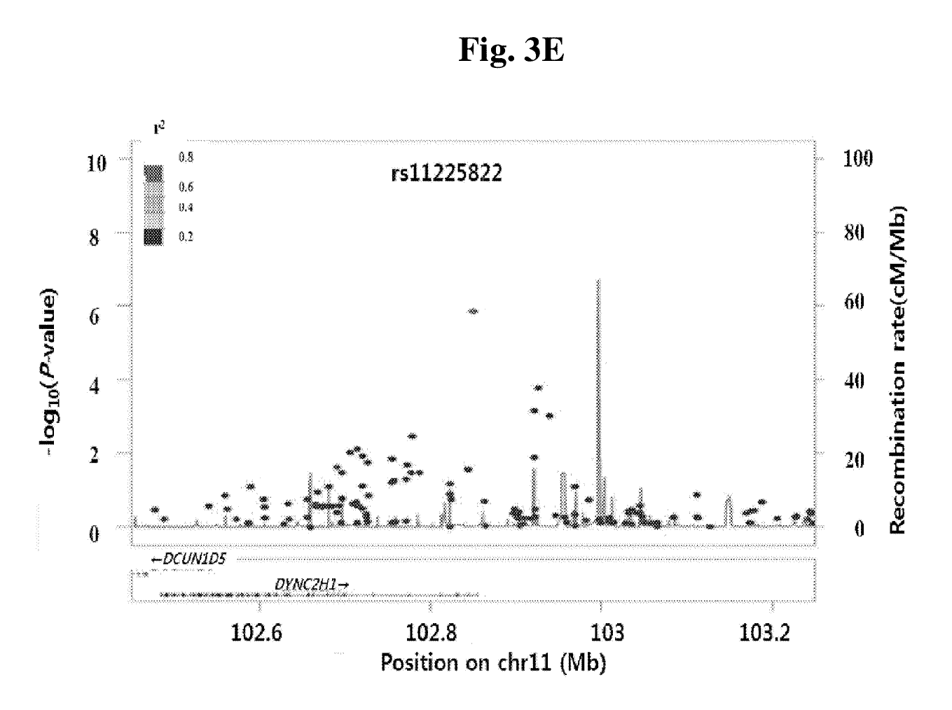

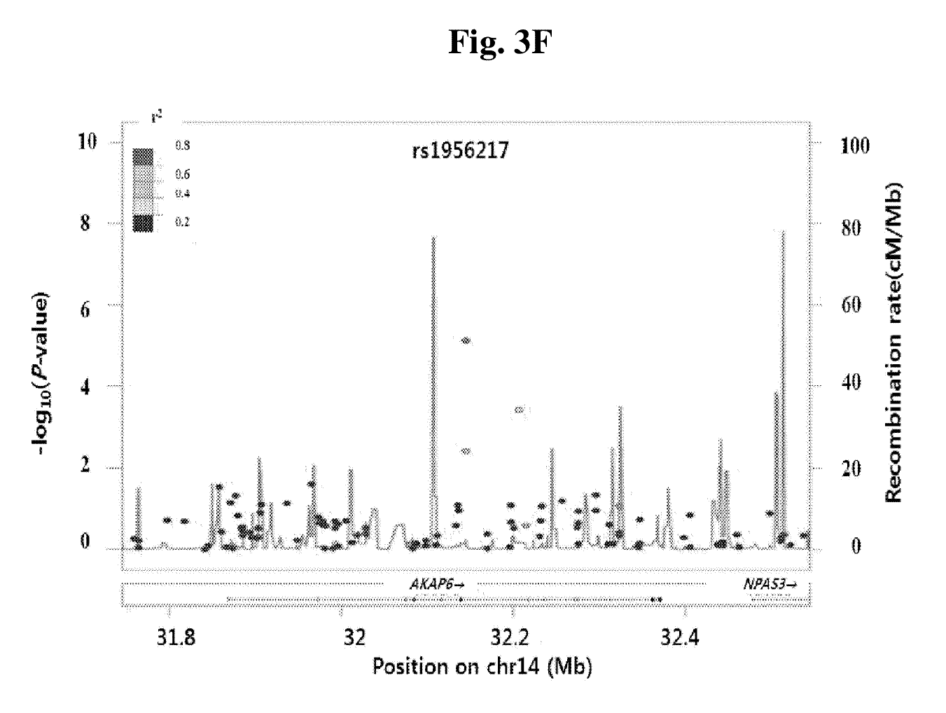

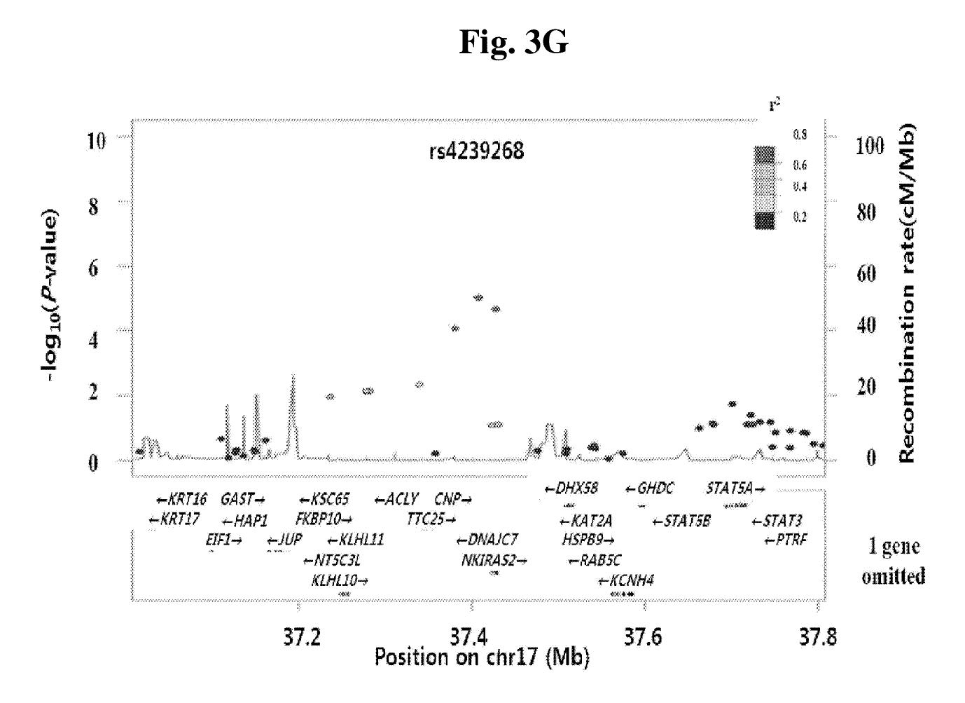

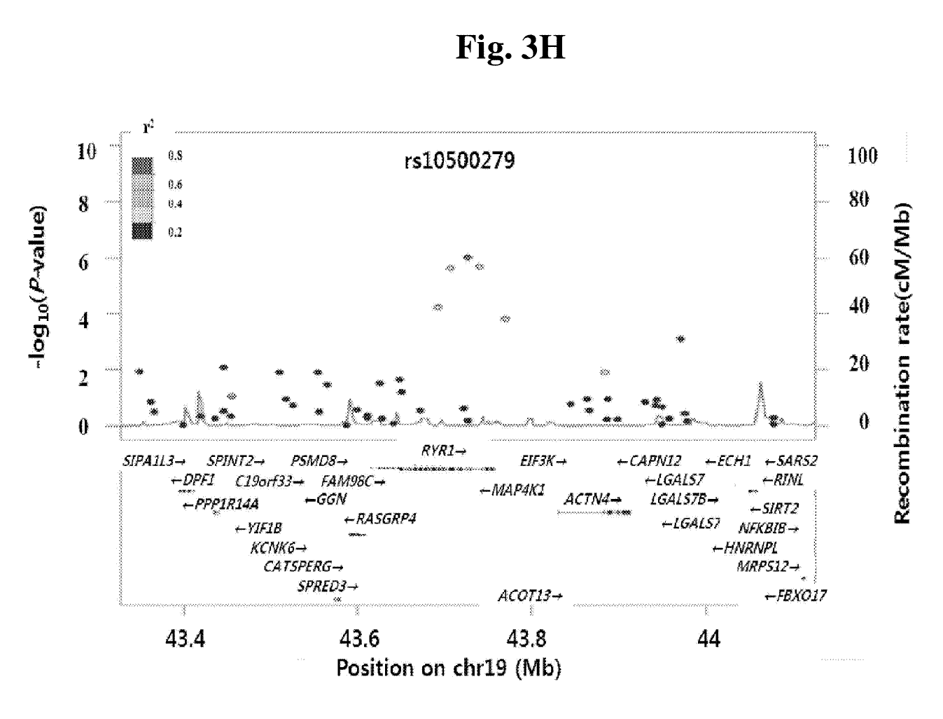

FIG. 2 illustrates the Manhattan plot of the GWAS results (A) and their P-values (significance probability) are shown in Table 2. None of the P-values for the associations met the multiple comparison criteria (Bonferroni's correction P-value <1.5×10⁻⁷). Therefore, instead of Bonferroni's correction criteria, a less stringent P-value (<1×10⁻⁵) was applied to further study in the replication sample. The GWAS on ECG-LVH identified 14 SNPs in eight suggestive association loci: one SNP in 5q35.1 (rs265992, P=1.2×10⁻⁶), one SNP in 6p22.3-22.1 (rs9295629, P=9.0×10⁻⁶), five SNPs in 8q24.2 (rs4909705, P=3.7×10⁻⁶), one SNP in 11p15 (rs17446021, P=4.9×10⁻⁶), one SNP in 11q21-q22.1 (rs11225822, P=1.4×10⁻⁶), one SNP in 14q12 (rs1956217, P=7.9×10⁻⁶), one SNP in 17q11.2 (rs4239268, P=9.9×10⁻⁶), and three SNPs in 19q13.1 (the best SNP: rs10500279, P=9.5×10⁻⁷). The signal plots for each of the eight loci are shown in FIG. 3a-h.

### Validation in Replication Sample

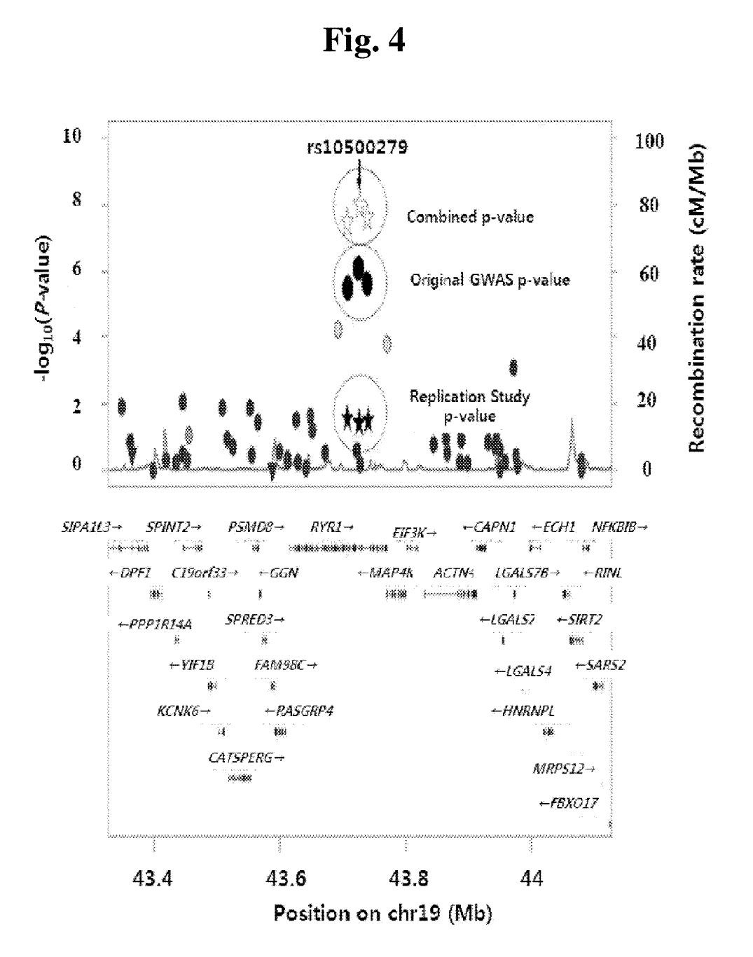

Twelve of the 14 SNPs that the present inventors identified were genotyped in the replication sample (207 cases and 597 controls). All genotypes had low missing rate (0.1-3.2%) and none of SNPs failed to meet the criteria of HWE. Of the 12 SNPs, 3 SNPs in RYR1, ryanodine receptor 1 (skeletal) in 19q13.1, were replicated at P-values that ranged between 2.7×10⁻² and 3.6×10⁻² in the hospital-based sample (replication sample) (FIG. 4 and Table 2).

Moreover, the combined analysis of the KARE/replication sample demonstrated that the association signals of all three SNPs passed the threshold of significance for genome wide associations (P<7.2×10⁻⁸) (Dudbridge F et al., Genet Epidemiol 32(3):227-234 (2008)). The three SNPs laid in introns of RYR1 gene and rs10500279 are the most significant SNP and these SNPs have an odds ratio of 1.58 (CI: 1.35-1.85) and P=1.0×10⁻⁸ (FIG. 4 and Table 2).

TABLE 2A
Logistic regression analysis results of the original genomewide association study and
replication study, controlling for antihypertensive drug-treated states, cohort, age, sex, and
cardiovascular risk factors as covariates

| | | | | | | KARE GWAS | | | | |
|---|---|---|---|---|---|---|---|---|---|---|
| | | | | Proximal | | (cases 398/controls 8432) | | | | |
| Chr | rsID | Position | Locus | gene | M | MAF | OR | L95 | U95 | P-value |
| 5 | rs265992 | 174846655 | 5q35.1 | DRD1 | A | 0.1 | 1.70 | 1.37 | 2.10 | 1.2E−06 |
| 6 | rs9295629 | 24654266 | 6p22.3-22.1 | TTRAP | T | 0.039 | 1.99 | 1.47 | 2.71 | 9.0E−06 |
| 8 | rs6577840 | 138805432 | 8q24.2 | FAM135B | C | 0.159 | 1.52 | 1.27 | 1.83 | 7.1E−06 |
| 8 | rs4909705 | 138805788 | 8q24.2 | FAM135B | T | 0.16 | 1.54 | 1.28 | 1.85 | 3.7E−06 |
| 8 | rs7825068 | 138807660 | 8q24.2 | FAM135B | T | 0.159 | 1.53 | 1.28 | 1.84 | 5.0E−06 |
| 8 | rs7840530 | 138811480 | 8q24.2 | FAM135B | A | 0.162 | 1.51 | 1.26 | 1.81 | 7.3E−06 |
| 11 | rs17446021 | 11761070 | 11p15 | GALNTL4 | A | 0.014 | 2.81 | 1.80 | 4.37 | 4.9E−06 |
| 11 | rs11225822 | 103345030 | 11q21-q22.1 | DYNC2H1 | C | 0.087 | 1.71 | 1.38 | 2.13 | 1.4E−06 |
| 17 | rs4239268 | 40154777 | 17q11.2 | DNAJC7 | C | 0.15 | 1.52 | 1.26 | 1.82 | 9.9E−06 |
| 19 | rs2071090 | 39015454 | 19q13.1 | RYR1 | G | 0.219 | 1.49 | 1.26 | 1.76 | 2.2E−06 |
| 19 | rs10500279 | 39035068 | 19q13.1 | RYR1 | G | 0.157 | 1.57 | 1.31 | 1.88 | 9.5E−07 |
| 19 | rs2960321 | 39048163 | 19q13.1 | RYR1 | A | 0.212 | 1.49 | 1.27 | 1.76 | 2.0E−06 |

TABLE 2B

| | | | | | | Replication study | | | | |
|---|---|---|---|---|---|---|---|---|---|---|
| | | | | Proximal | | (cases 207/controls597) | | | | |
| Chr | rsID | Position | Locus | gene | M | MAF | OR | L95 | U95 | P-value |
| 5 | rs265992 | 174846655 | 5q35.1 | DRD1 | A | 0.088 | 0.76 | 0.39 | 1.48 | 4.2E−01 |
| 6 | rs9295629 | 24654266 | 6p22.3-22.1 | TTRAP | T | 0.037 | 0.61 | 0.17 | 2.13 | 4.4E−01 |
| 8 | rs6577840 | 138805432 | 8q24.2 | FAM135B | C | 0.153 | 0.94 | 0.59 | 1.51 | 8.1E−01 |
| 8 | rs4909705 | 138805788 | 8q24.2 | FAM135B | T | 0.149 | 1.00 | 1.00 | 1.01 | 7.7E−01 |
| 8 | rs7825068 | 138807660 | 8q24.2 | FAM135B | T | 0.154 | 0.94 | 0.58 | 1.50 | 7.8E−01 |
| 8 | rs7840530 | 138811480 | 8q24.2 | FAM135B | A | 0.153 | 0.93 | 0.58 | 1.51 | 7.8E−01 |
| 11 | rs17446021 | 11761070 | 11p15 | GALNTL4 | A | 0.011 | 5.63 | 0.74 | 42.88 | 9.5E−02 |
| 11 | rs11225822 | 103345030 | 11q21-q22.1 | DYNC2H1 | C | 0.091 | 1.35 | 0.74 | 2.48 | 3.3E−01 |
| 17 | rs4239268 | 40154777 | 17q11.2 | DNAJC7 | C | 0.131 | 0.86 | 0.51 | 1.46 | 5.8E−01 |
| 19 | rs2071090 | 39015454 | 19q13.1 | RYR1 | G | 0.236 | 1.59 | 1.05 | 2.41 | 2.7E−02 |
| 19 | rs10500279 | 39035068 | 19q13.1 | RYR1 | G | 0.173 | 1.65 | 1.03 | 2.65 | 3.6E−02 |
| 19 | rs2960321 | 39048163 | 19q13.1 | RYR1 | A | 0.232 | 1.59 | 10.4 | 2.42 | 3.1E−02 |

TABLE 2C

| | | | | | | Combined analysis | | | |
|---|---|---|---|---|---|---|---|---|---|
| | | | | | | (cases 605/controls 9029) | | | |
| Chr | rsID | Position | Locus | Proximal gene | M | OR | L95 | U95 | P-value |
| 5 | rs265992 | 174846655 | 5q35.1 | DRD1 | A | 1.46 | 1.20 | 1.78 | 1.6E204 |
| 6 | rs9295629 | 24654266 | 6p22.3-22.1 | TTRAP | T | 1.62 | 1.21 | 2.18 | 1.2E203 |
| 8 | rs6577840 | 138805432 | 8q24.2 | FAM135B | C | 1.38 | 1.18 | 1.63 | 9.2E205 |
| 8 | rs4909705 | 138805788 | 8q24.2 | FAM135B | T | 1.42 | 1.20 | 1.67 | 2.6E205 |
| 8 | rs7825068 | 138807660 | 8q24.2 | FAM135B | T | 1.39 | 1.18 | 1.63 | 8.0E205 |
| 8 | rs7840530 | 138811480 | 8q24.2 | FAM135B | A | 1.38 | 1.17 | 1.62 | 9.6E205 |
| 11 | rs17446021 | 11761070 | 11p15 | GALNTL4 | A | 2.26 | 1.47 | 3.48 | 2.2E204 |
| 11 | rs11225822 | 103345030 | 11q21-q22.1 | DYNC2H1 | C | 1.62 | 1.33 | 1.97 | 1.2E206 |
| 17 | rs4239268 | 40154777 | 17q11.2 | DNAJC7 | C | 1.38 | 1.17 | 1.63 | 1.5E204 |
| 19 | rs2071090 | 39015454 | 19q13.1 | RYR1 | G | 1.49 | 1.30 | 1.72 | 3.6E208 |
| 19 | rs10500279 | 39035068 | 19q13.1 | RYR1 | G | 1.58 | 1.35 | 1.85 | 1.0E208 |
| 19 | rs2960321 | 39048163 | 19q13.1 | RYR1 | A | 1.50 | 1.30 | 1.73 | 2.5E208 |

Chr: chromosome;
rsID: SNP ID in dbSNP database;
MAF: minor allele frequency;
M: minor allele;
OR: odds ratio;
L95 and U95: confidence interval lower and upper 95%

Having described a preferred embodiment of the present invention, it is to be understood that variants and modifications thereof falling within the spirit of the invention may become apparent to those skilled in this art, and the scope of this invention is to be determined by appended claims and their equivalents.

What is claimed is:

1. A method for identifying left ventricular hypertrophy (LVH) or an increased risk of developing LVH in a human subject, comprising:
(a) obtaining a biological sample from the human subject; and
(b) identifying at least one single nucleotide polymorphism (SNP) in the biological sample, wherein the SNP is selected from the group consisting of: position 301 in SEQ ID NO:1, position 201 in SEQ ID NO:2, and position 201 in SEQ ID NO:3 as SNPs of RYR1 (ryanodine receptor 1) gene; position 201 in SEQ ID NO:4 as a SNP of DRD1 (dopamine receptor D1) gene; position 256 in SEQ ID NO:5 as a SNP of TTRAP (toll-interleukin 1 receptor domain containing adaptor protein) gene; position 201 in SEQ ID NO:6, position 502 in SEQ ID NO:7, position 301 in SEQ ID NO:8, and position 960 in SEQ ID NO:9 as SNPs of FAM135B (family with sequence similarity 135, member B) gene; position 301 in SEQ ID NO:10 as a SNP of GALNTL4 (UDP-N-acetyl-alpha-D-galactosamine: polypeptide N-acetylgalactosaminyltransferase-like 4) gene; position 251 in SEQ ID NO:11 as a SNP of DYNC2H1(dynein, cytoplasmic 2, heavy chain I) gene; and position 401 in SEQ ID NO:12 as a SNP of DNAJC7 (DnaJ (Hsp40) homolog, subfamily C, member 7) gene, and wherein the presence of: a G allele at position 301 in SEQ ID NO:1, a G allele at position 201 in SEQ ID NO:2, an A allele at position 201 in SEQ ID NO:3, an A allele at position 201 in SEQ ID NO:4, a T allele at position 256 in SEQ ID NO:5, a C allele at position 201 in SEQ ID NO:6, a T allele at position 502 in SEQ ID NO:7, a T allele at position 301 in SEQ ID NO:8, an A allele at position 960 in SEQ ID NO:9, an A allele at position 301 in SEQ ID NO:10, a C allele at position 251 in SEQ ID NO:11, or a C allele at position 401 in SEQ ID NO:12 is indicative of the development of LVH or the increased risk of developing LVH in the human subject.

2. The method according to claim 1, wherein the SNP is selected from the group consisting of position 301 in SEQ ID NO:1, position 201 in SEQ ID NO:2, and position 201 in SEQ ID NO:3.

3. The method according to claim 1, wherein the SNP is at position 301 in SEQ ID NO:1.

4. The method according to claim 1, wherein the identification of the SNP is carried out by microarray analysis or gene amplification.

5. The method according to claim 1, wherein the human subject having LVH or an increased risk of developing LVH has an increased risk of developing a cardiovascular disease.

6. The method according to claim 5, wherein the cardiovascular disease is arrhythmia, hypertension, stroke, arteriosclerosis, atherosclerosis, angina pectoris, myocardial infarction or heart failure.

7. The method according to claim 1, the human subject is Asian.


SEQUENCE LISTING (12 sequences)

SEQ ID NO: 1 - DNA, 601 bp, Artificial Sequence
  RYR1 SNP 301
tcatgctcaaagttgccagccggcgtggatgtggctctgcccaaaagcttgtcatcagggcttctcgctggcgtgactggggtggccctggccccgggtctgcacccaaggctccagaacacggctgtgggactctgtgccctgtgtctctgcttccagatctttctggatgtctcttgcatctttggtcttcctgtctccttgtctttttcagtctctcagtgtctttttcttgcaacttctcttgtcgcttgaactctttgtggacctgcatctttgtttcattcttgagaacttggtnttgggatgtgaagtgtggggttgtgcatgctgtggagggggtattgtactggggttcctaggggattctggaagaggactgctagaagttgagacaggcccagaacgggggaaaatctggatgggcctgggttagaaattggagccaggcaagcatggtggtatgtgcctgtagtcccagctacttgggaggctgaggcaggaggatcacttgaagccaagagttcaagtccagcctgggcaacatggcaagacaccatctctaaaaataaatttgtttaaaaaacaagaaactgggaat

SEQ ID NO: 2 - DNA, 701 bp, Artificial Sequence
  RYR1 SNP 201
tctagattagagcctggggctgaggaaatgttttgcttctttatcttacttgcggcagatgacacccatatcaggcattcatgatgtaaggtccctgttgagcaccaccttccatttccataatccttgttcctctttccctcacccctttgcagccttgccaatgtctcacgaacacttaatccatttgctctgcttctntctggtaactatattcaaggctgccatatactgttccgcaggtcgtgcactgcacaaaggcacgatctctgagagcattcacatcctacacataatggtgtatttattacaatagtttagttttccagcagatggcagtaaagcatccagcatgttataacttccctacaggaagtgttttaggggacgcctttttttctaatttgctcaaaggtgccccaggggctggcagaaaccctaattcgttgtcatctgactttttaaaaggagttaaacttagaatgcaattcctccgtgtcacagcagctgaagttgtgctgttggtatcctaaaattctagagagtgttggtatcatcatgtagaattccaaatcctgcagggctaattcatccgccaccatctagtctaggttgcaaaagctagaaatccagtgcaaagtggtggcttaagaaaaataaagaatttatcagttcatattacagatccagggcttagagtg

SEQ ID NO: 3 - DNA, 701 bp, Artificial Sequence
  RYR1 SNP 201
gagcccactgtgggggctgatagtccagtgggaaggggcagatgcaaataacgaaatacacgaagtaattgcaggttataatctgtggtctgaagggtgtgggagtgagcagggtgtggtaagccctgtaaaccggctggtggcggaaggccttctgcaggaggggacagcgaagctgagagttgaaagataccatatgamtcagcgaggctgtggtgtcccaggcaaaggggacagtaaatggaaaggctgaaaaatgggaacaagagggacagagagcagcctgggcaacatggcgaaaccaaaccctgtccctacaaaaaatacaaaaattagctaggcatggtggcctatgcctgaagtcccagctacttgggaggctgaggcaagagaatcacttgaacccaggagggggaggttgctgtgagccaagatcgcgtcattgcactccagcctgggtgacaagagcgaaattctgtctcaaaaaaaagaaataaaaatacaaaaattagctaggcatggtggtgcatgcctgtattcccagctactcgggaggctgaggcaggagaatcgcttgaacccgggaggcggaggttgcagtgagccgagattgcaccactgcactccagcatgggcaacagagtgagactctctcaaaaataaaataaaataatacaataaaatataaaataaaataaaat

SEQ ID NO: 4 - DNA, 739 bp, Artificial Sequence
  DRD1 SNP 201
tgaggtaaagaacactcattttattcttatgggtcttgaaatccatgtctttcactttttaagaaataggattaaagcatcaaagaaaagtccttattgaagggctttgcgtgactggtcaagagtgaattcaccagccatctctccaggctgctgtcagctctggccacaggggacaggccaccattgccagatcagggmaactaatgaaccaagaaaaaaggaactacccctttactgaaggcccaccacatgccaggggcataccacttgccaagcactctacacagtctagggatgcatagctaaaaggctaaatgcacacaccctggaaacagcctctctgggtttgaagcccaaatctgggctattggctggaggccttagtcaagtctcttaacctctccatgcctcagtttctcctctgcacaatgagggctgtaacactagcttcttcattgtattgttgtgggttgggatatacagagagcataaagtaattcctggtacacagtaagagttctctttctttaaatattaaccataattattactactgtctttttcgattcttacacccactctgtgagatagtggttctcatcctcttctggtagatgaggaaactgcagctcagagcaacaaggcaacagtggctggggaagtgactggaagagatgaatttagccctggtcaggcaaagcatgggcctgtggtctgcactccctcacctccagct

SEQ ID NO: 5 - DNA, 511 bp, Artificial Sequence
  TIRAP SNP 256
caactgaatagaatgctcattcatactcatacatgtacacctcttgcaacttgcaaaagtttgctcatggtggtttctctacttggactctttttaatatgtatgtcttacatatttttcagggttcatttcaaataccatctcctctataaaactctcactaaacaatctggctaaaagtcatctctcctttctctaaacttccacacatcatttatacctctcctgtggcacttatgcctttcttatgttttanttactatatacacactctcccttactaatctatatactatatcagagcaagatctatttttcatttttgtaagtctcatagagtaaaatatagcagcatgtatagagtagaaagtaaaaacattactttaggaagcaaatgtggaatgtcagcaaactcaaatattcttaagaaaataatagactgagaattctatctgcatttaaaatttatgtaaaaaattaattttagagagtgttaaagactatctaaaag

SEQ ID NO: 6 - DNA, 1012 bp, Artificial Sequence
  FAM135B SNP 201
gcattactgagctgctgagccagcactatggccacctaccctcagaaagcctttgacttcagatggctaataccttgactacttaaacattataaattgatattctgttacttgcagcaaaaagtaattttagctgaaacggaatttcacactcaaagtgactggggcactgcaagttacagacccaaggataaggatttnactaattagcaaatatagttatagcaggagataagaatccaacacttgcaggcatgttagacaggattcccgcttgacccccaaggttcctgcctcttggtgtactcatacccactctgttattcagtccatcactaaccgaggtaccgctgtgaagaggttttgcagacataatgaagttccctaatcaaatgacctaaaattagaaagactatctaaatgggtctaacttagttacgtgaaccttttaaaagcagagagttttctctggatggctaaagaagagaaagtcagagagatgtgtctagaagttaaaaaaataaaaaaattttaaaaagcatgtttggaactactatgggagccacatcattaggcagctttattgatatgagagacagtccctggccaacagccaccaggaaaatgcaacctcagtcaatagctgcaacgaaattaatgtttccaacaattggtgagcttggaaaagaccttgagtctcaaataagaaccacatgctctgccagcatctcaatttcacctctgtgagaccctaagcagagaacccagccatgccatcctgttctccgaatccatggaaaccgtgagatatattttaagctgctagattgcgataatttgttatgaagcaacagaaaactaatgcagtgggctaaaagtagttgaccctggttatagaggaggaagcatttaattaaaatatctgcgactgcacattgagactaacaccacatcccatctgaggctgtaatattaggggaaaggaaaaaaaaagcataataatggatattta

SEQ ID NO: 7 - DNA, 1011 bp, Artificial Sequence
  FAM135B SNP 502
acttcagatggctaataccttgactacttaaacattataaattgatattctgttacttgcagcaaaaagtaattttagctgaaacggaatttcacactcaaagtgactggggcactgcaagttacagacccaaggataaggatttgactaattagcaaatatagttatagcaggagataagaatccaacacttgcaggcatgttagacaggattcccgcttgacccccaaggttcctgcctcttggtgtactcatacccactctgttattcagtccatcactaaccgaggtaccgctgtgaagaggttttgcagacataatgaagttccctaatcaaatgacctaaaattagaaagactatctaaatgggtctaacttagttacgtgaaccttttaaaagcagagagttttctctggatggctaaagaagagaaagtcagagagatgtgtctagaagttaaaaaaataaaaaaattttaaaaagcatgtttggaactactaygggagccacatcattaggcagctttattgatatgagagacagtccctggccaacagccaccaggaaaatgcaacctcagtcaatagctgcaacgaaattaatgtttccaacaattggtgagcttggaaaagaccttgagtctcaaataagaaccacatgctctgccagcatctcaatttcacctctgtgagaccctaagcagagaacccagccatgccatcctgttctccgaatccatggaaaccgtgagatatattttaagctgctagattgcgataatttgttatgaagcaacagaaaactaatgcagtgggctaaaagtagttgaccctggttatagaggaggaagcatttaattaaaatatctgcgactgcacattgagactaacaccacatcccatctgaggctgtaatattaggggaaaggaaaaaaaaagcataataatggatatttaagtttcttatagttgtcagcaatgctgtacaacagagatatcagattaggtatg

SEQ ID NO: 8 - DNA, 601 bp, Artificial Sequence
  FAM135B SNP 301
ccctgtatctctaaggggattcattacttaatgggtacagtgtatactatttgcatgatggatatcctaagactcctgatttcaccaggatacaacctatgcatgtaataaaattacacttgtctaccatacatttacacaaataaataagatatttttccatttggaagtctattattttacaatgtgaagcattttttttctgtagggtacaaggagacgatggggttttgcagaaaaagaaaaaatgttcattgtatgaaaataaacagtgggagaaaatcacgtcatgcctaagacygacttgataatccatatggctcagcattgttgttaggcagctggctcccttttgttcatactaaaatggcccacaaaagcattccatagattgacctcaagattccctgcttacaaggttttgtgattagttttcaataattatatttgtttgacctccgcaactcccatacctttgaaacatagtgaattattgttaggtgattaaacctcatacatgttatttttaaaatcacattttaatgaattgatccttctatgattctcagagacctttcaattcaagcgtcatttggttcta

SEQ ID NO: 9 - DNA, 1793 bp, Artificial Sequence
  FAM135B SNP 960
atgggtataatcacatctactgtaaaaccagagaaaattaccgaggcaagtttcaatcaatttagaggttaattttgcaaaggtggagaacatgactgggaaaaaggaacaaaaaattgcaggaacacctgtgatcagtgctttcttcaaagagggtttgaggacttgagtatttaaaggggaaagaatggacagtagggaaaagaggaaagaacaagttggggtgggttggtaaaagagacaagtggttgtattattttgaggctttgatccgcattcaccgaattcacattttacatgtgaatgggggaagaagaacagtcaactatgaattagccttgcactcagtgaatctgtatttttcatacaaggtgaaataaacagagtagaggaagcagtcacatacgcaattgtttcagatgagtggagggatgacttctagtcctgtctttgtcctgtacctttttttagattgtgcttcatggtatttttttttttctttttgagacggagtctcgctcttgtcgcccaggctggagtggagaggcacaatctcggctcagtgcaaactctgcctcccgggttcaagctattctcctgcctcagcctcctgagtagctgggattacaggagcctgccaccatgcctggctaatttttgtacttttagtagagacagggttttgccatgttggccaggctggtctcgaactcctgaagtcaggtgatctgactgcctgcctcagtctcccaaagtgttgggattataggtgtgagccactgtacccagccatcattgtattttttaaaaacatttttctagcttttatttcaggtccaggggtacatgtgcaggtttattttaggttcaggggtacatgtgcaggtttgctatataggtaaattgttgtgttgtggtggtttggtgtatagcttattttatcaaccaggtaataagcaragtattcagtaggtatgtttttgatcctcaccctcctcccacactccacccttaaataggccctggtgtcccttcgttgtgtcatatgaactcgatgtttagctcccacttgcaagtgagaacataaggtatttcattttctgttcctgcattagttcacttaggatgatggcgtccatctcgaaccatgttgctgcaaaggacataatctcattcttttaatggctgtgtggtaatccgtggtgtatatgtacattttctttatccagtctaccattgatgggcatttatgttgattccatgtccctttgctattgtgaatactgctgacatgaacatatgcacacatgtgtgtttattgttttgtacctttgaagataagctgtttatttacattggcaggataaaattcaacagaactttgttttagggtaaagataagagggaccacagggatttccttgtgagcaaatgctgaggaagttcctctgggtgggtacatgaccttctatctttgcagctatctacgaaggaacaaaatgggaggcagttttgcaggactcagtttccaggcttaacttttccctttggcatagtgaattccaggccctaagattttcttttcttttcacaataccatacatccattccaggataacaagaacttcaattgagtcaatgcctgtaaaaattcttcaaaaagcaaggaattgaaaaataataggtttgagtaatgatgattgcattgttgagtcatttagagatcatagttaaggtagcttgaaacaccttataattttattgcctcataaccttcaggagagtaacgcaaa

SEQ ID NO: 10 - DNA, 601 bp, Artificial Sequence
  GALNTL4 SNP 301
tgatcctcagagctcagcaagtttatactggaaatgccaagtttaaaatctcggaaagaatgatgttcactcatcccatatactttttgaggatgtatattccaggcaatgtactcaacactggatgtacagcaatgaagaaggctgatgcagtctctgctctctagagccaacagtatagtgggaaaggttgtcattttgcaactaattacagactcattatttaattacaactttgacgaatgctgttaaccaaaaaatacaggagaatgagcccaggtaatgatacaaggtgggaggngtgaaatcagaaaatgcttccccaaggaagtggggaagttcagcccagagaaaaggtaaggggtttagcccagaggaaagataaggaaagtgtattccaggcagaagaaactgtatatacaaagactccgaggcagcagaaacaaggaaggactaaaggaaggtcactgtgcttacaatgtacagaatgaagagaagaacaatacaagatgagctggaggggggcacggtggaggcatggtgggggcatggagagcatgtgcaggcagggttagattcattaggaccttttgcactaaag

SEQ ID NO: 11 - DNA, 501 bp, Artificial Sequence
  DYNC2H1 SNP 251
ttcactaacatattttgtatgttattttttttcttcaaggacttattatgaaagtaatgatgttatcactatattgttgaaaaatcagggaagtatatctttaccaatatacattttgaaacctagctagacattcttaacagaacaaagtcagagtattcattggtggcaagctgttttgtttcctattttgagatttttttcccccagaattgcatcactgaattgtgctacttgtacatacattagamctccgatttcctatcatttcctcttctaaaaaagaactgttcattgacttgattataaacattcagaaagcatgtgttaaaataagttggactgtgcatagactgatgaatatattttgttttgtcttcatatgtgttttgttatgaaatttaattgaaattggccaaatagctaatatgagtaacgtaataattttgttttcattgtttggttttgcttttccttgctttctttggtttgcaaactaag

SEQ ID NO: 12 - DNA, 801 bp, Artificial Sequence
  DNAJC7 SNP 401
tgtgtcagcagtataaagcttgttagtcgaaagtgaaataatgtacagggctgctgaaaggtgcccctagtctcctccttcctaagacactacccctatgganggtcggggagttcaggactggcttctagaaaaaatgcaaaggatgattttggtggacagttactaataactactgaggccaggtactttccatacagtatcctctataaaacacagtccggtgaacttcattattcccatttttcaaaagaggaaataaggcctgggggttaaataacttgcctgaggtcaggatgttacccatgtttgtcagaatacaaagcttgtgcactttctactatgccaagctttctctctaatgcttgcctccgcttactgctaactattttgaaaattantctgtactacgaggagtaagacatggacaatatatgtaagacatggacaatacatataaatttgtttaaactaagacacacagtacaccccacatgtaatattcaaccccagaaccaaaatcggtatttaaataagctaaatgacattcctaacaattagtcatagaggaagcagggctcctttctctttaagatgcaagacctagtgaactggactttgcctccccaaagaaatgcatttcattttagtaaatggtgagtagattccattctagagcaaacaaagcaagtaatgtagagtcagcccacagcaaaaagaacaagaagaattgtgttgtgacaagttgccatgtttttaacctcacactgcacagcatcaggccagaattagctattccca